(19) United States
(12) Patent Application Publication
(10) Pub. No.: US 2010/0325330 A1
(43) Pub. Date: Dec. 23, 2010

(54) Multimedia multifunctional photo kiosk combination device

(76) Inventor: Hsien-Rong LIANG, Taipei City (TW)

Correspondence Address: Muncy, Geissler, Olds & Lowe, PLLC, 4000 Legato Road, Suite 310, FAIRFAX, VA, 22033, US

(21) Appl. No.: 11/976,727

(22) Filed: Oct. 26, 2007

(51) Int. Cl. G06F 13/00; G06F 12/00

(52) U.S. Cl. 710/302; 711/115; 711/E12.001

(57) ABSTRACT

The present invention provides a multimedia multifunctional photo kiosk combination device, in which a multimedia device is structured from a display interface and an access device.

The access device is structured from a housing and a connector module, and the housing is configured with a first connector and an embedding slot that enables the connector module to be disposed and clamped therein. An insertion hole is defined in the connector module, and the insertion hole enables a key to be inserted therein to enable the connector module to be pulled out. Accordingly, the key need only be inserted into the insertion hole of the connector module to enable the connector module to be pulled out and separated from the housing, thereby achieving the objectives of convenient exchange and reduction in time cost.

### BACKGROUND OF THE INVENTION

(a) Field of the Invention

The art of the present invention provides a multimedia multifunctional photo combination device, wherein an access device is structured from a housing and a connector module. Hence, when the access device is damaged, the connector module need only be pulled out from the access device and exchanged with a good connector-module.

(b) Description of the Prior Art

A previous patent application of the applicant, with application number 91204064, discloses a connector which is inserted into an adapter box and embedded onto connector terminals for joining thereto. The connector being able to be extracted from and inserted into the adapter box is used to achieve functionality to quickly pull out the connector. However, when inserting the connector into the adapter box, the connector is unable to be completely disposed within the adapter box, resulting in the connector being unable to form an integral body with the adapter box; moreover, the connector can be easily pulled out and carried off by other people, which is often an area of condemnation for the user.

Furthermore, because access devices of prior art multimedia devices are embedded within the multimedia devices, thus, the entire multimedia device must be disassembled for repairs when the access device is damaged, causing annoyance to the user and wastage in cost.

In addition, memory card slots of prior art multimedia devices which provide for the insertion of readable devices have a single specification. If the user wants to use a readable device of another specification, then the readable device cannot be inserted, moreover, the memory card slots do not support readable devices of relatively high capacity. Furthermore, restrictions are imposed by the design of the multimedia device itself, thereby preventing separately extending the transmission interfaces, causing inconvenience to the user; what is more, compatibility of the multimedia device is low, and manufacturing cost is high.

Hence, the inventor of the present invention proposes to resolve and surmount existent technical difficulties to eliminate the aforementioned shortcomings of prior art.

### SUMMARY OF THE INVENTION

The art of the present invention provides a multimedia multifunctional photo kiosk combination device, wherein an access device is structured from a housing and a connector module. Hence, when the access device is damaged, the connector module need only be pulled out from the access device and exchanged with a good connector module, thereby achieving the objectives of convenient exchange and reduction in time cost.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of the present invention.

FIG. 2 shows an exploded elevational view of the present invention.

FIG. 3 shows a first view of an embodiment according to the present invention.

FIG. 4 shows a second view of an embodiment according to the present invention.

FIG. 5 shows a third view of the embodiment according to the present invention.

FIG. 6 shows a fourth view of an embodiment according to the present invention.

FIG. 7 shows a fifth view of an embodiment according to the present invention.

FIG. 8 shows a sixth view of an embodiment according to the present invention.

### DETAILED DESCRIPTION OF THE PREFERRED EMBODIMENTS

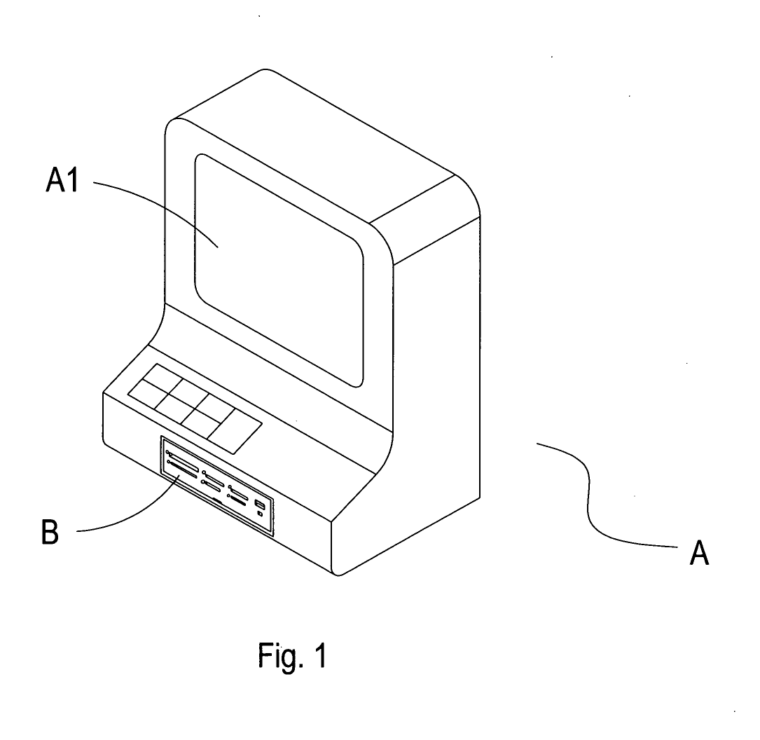

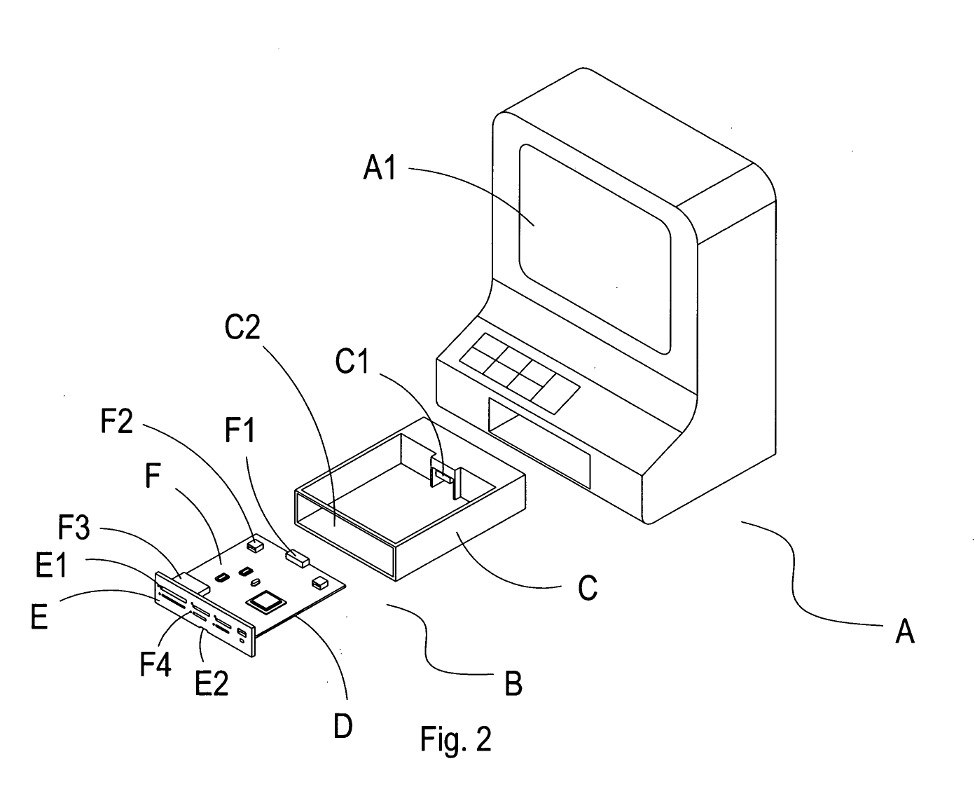

Referring to FIG. 1 and FIG. 2, which show a multimedia multifunctional photo combination device as provided by the present invention, wherein a multimedia device A is structured to comprise a display interface A1 and an access device B.

The access device B of the multimedia device A is structured from a housing C and a connector module D, wherein the access device B is embedded within the multimedia device A. Moreover, the housing C of the access device B is configured with a first connector C1 and an embedding slot C2, wherein the first connector C1 of the housing C enables connecting and electrical conduction with a second connector F1 of the connector module D.

The connector module D of the access device B is structured from a faceplate E and a circuit board F, wherein the circuit board F of the connector module D is configured with the second connector F1, a plurality of expansion devices F2, memory card slots F3 and indicator lights F4. Moreover, a plurality of insertion slots E1 are defined in the faceplate E of the connector module D corresponding to the memory card slots F3, and an insertion hole E2 is defined at an area of the faceplate E to enable insertion of a key therein.

The memory card slots F3 of the access device B have a plurality of different specifications, and the access device B is configured with the plurality of indicator lights F4. The plurality of indicator lights F4 of the access device B correspond to the plurality of memory card slots F3 of different specifications of the access device B.

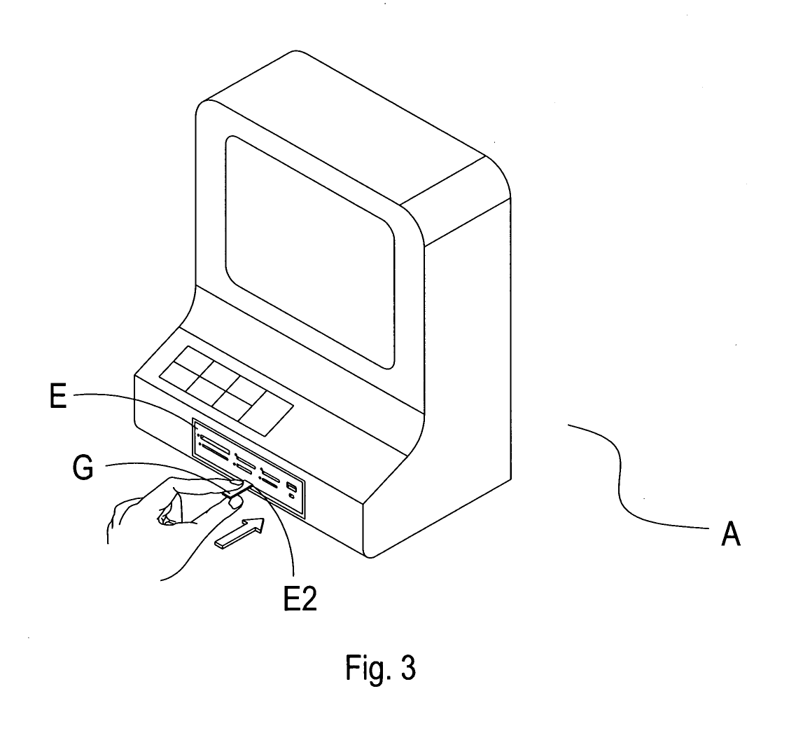

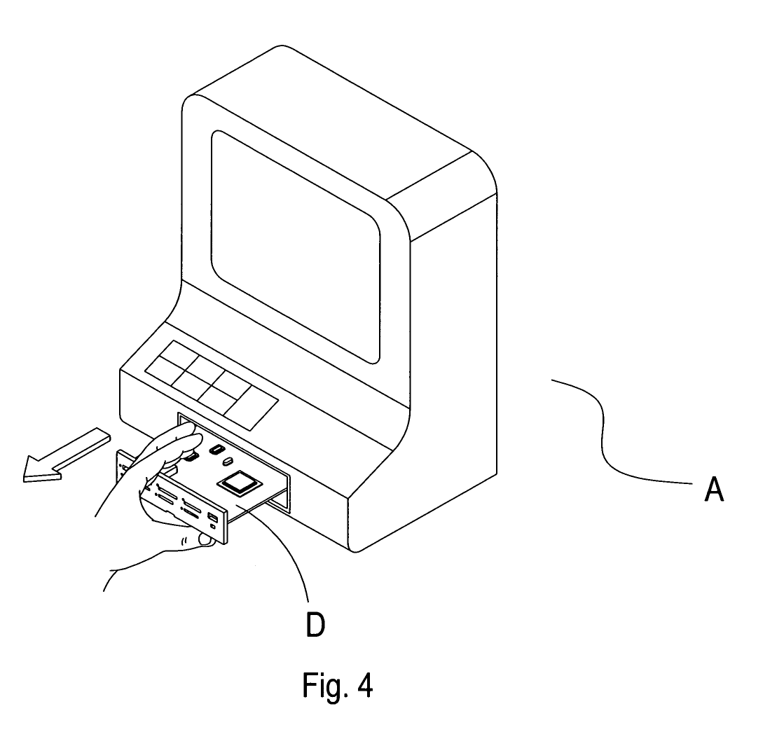

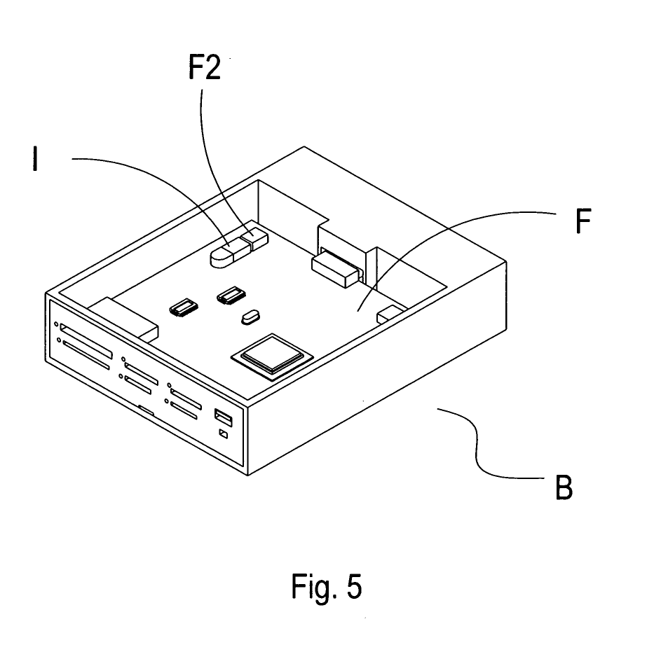

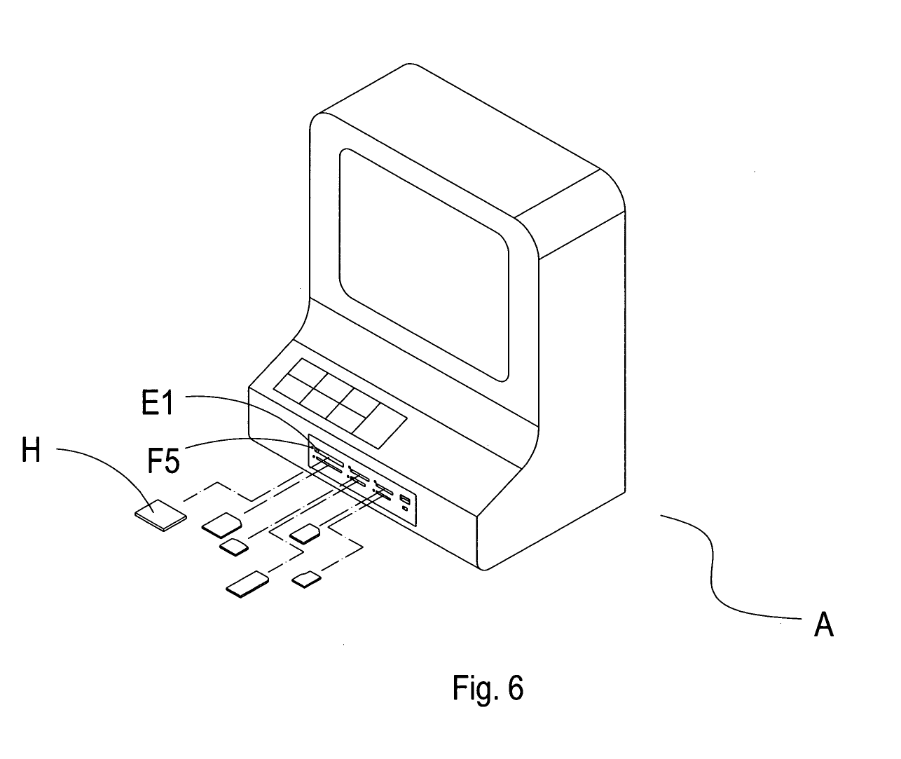

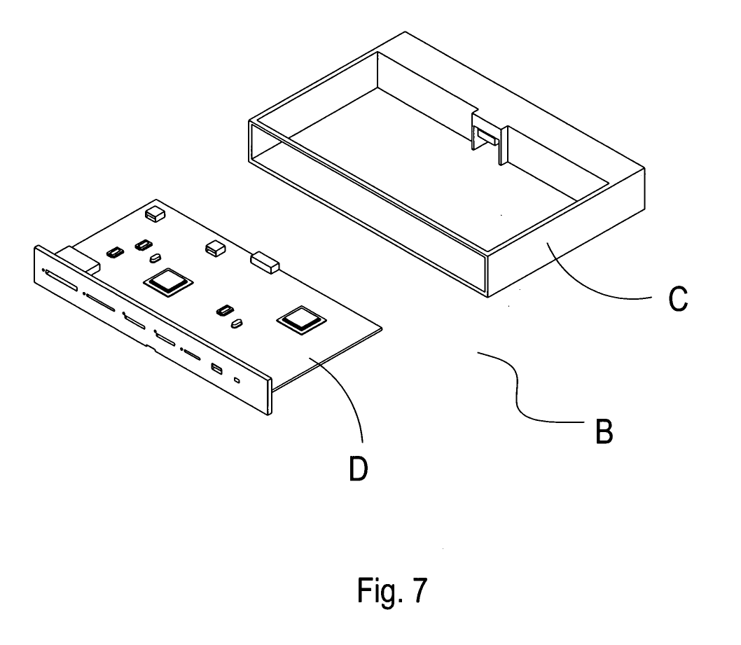

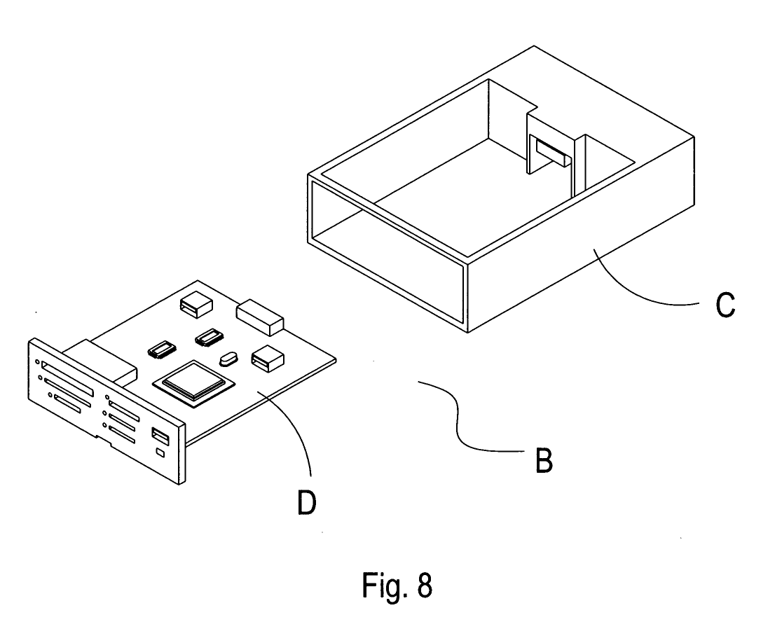

Referring to FIG. 2, FIG. 3, FIG. 4, FIG. 5, FIG. 6, FIG. 7 and FIG. 8, which show embodiments of the multimedia multifunctional photo combination device as provided by the present invention, wherein the multimedia device A is configured with the access device B, and the connector module D is embedded within the housing C of the access device B. With such a configuration, when the access device B is damaged, a key G need only be inserted into the insertion hole E2 of the faceplate E to enable the connector module D of the access device B to be directly drawn out from the embedding slot C2 of the access device B, whereupon the second connector F1 of the circuit board F is separated from the first connector C1 of the housing C, thereby enabling exchange with a good connector module D. Accordingly, the present invention achieves facilitating a user to conveniently exchange the access device B, and, moreover, achieves the objective of saving on man-hours.

Hence, when using the present invention, the user does not need to first insert a readable device H into the memory card slot F3, but can first select the specifications of the readable device H required from the display interface A1 of the multimedia device A, whereupon the indicator light F4 for the readable device H specifications selected by the user lights up, at which time, the readable device H need only be inserted into the memory card slot F3 corresponding to the lit indicator light F4. Accordingly, data needed to be transmitted can then be transmitted to the multimedia device A, thereby enabling the user to proceed with multimedia services required via the display interface A1 of the multimedia device A.

The connector module D is configured with the plurality of expansion devices F2, moreover, the expansion devices F2 can be separately installed with expansion members I, thereby achieving the objective of providing extensible transmission interfaces. The expansion members I can be configured as wireless devices, printer ports, blue-tooth, flash drives, credit card card readers and related expansion members able to transmit data.

The access device B is configured with the memory card slots F3 having a plurality of specifications, moreover, the memory card slots F3 of the access device B enable the readable devices H of diverse specifications to be inserted therein for use thereof. The readable devices H include the CF card (Compact Flash Memory Card), the MS card (Memory Stick Memory Card), the SD card (Secure Digital Memory Card), the Mini SD card (Mini Secure Digital Memory Card), the Micro SD card (Micro Secure Digital Memory Card), the MMC card (Multi Media Memory Card), the RSMMC card (Reduced Size Multi Media Memory Card), the SM card (Smart Media Memory Card), the XD card (xD-Picture Card), the M2 card (MS Micro Card) and the MMC Micro card (Multi Media Memory Card Micro), thereby facilitating inserting the readable devices H of diverse specifications.

The access device B is configured with the plurality of indicator lights F4, and the indicator lights F4 correspond to the respective memory card slots F3 of the access device B, which enables the indicator lights F4 of the access device B to light up when the readable devices H are inserted into the memory card slots F3 of the access device B, and accordingly enable distinguishing whether or not there is electrical conductance between the readable devices H and the access device B.

The access device B can be configured with 3.5 inch, 5.25 inch and a plurality of other size specifications, and can be used in a desktop computer, a notebook computer and related devices.

In order to better explicitly disclose advancement and practicability of the present invention, a comparison with prior art is described hereinafter:

### SHORTCOMINGS OF PRIOR ART

1. The connector is unable to form an integral body with an adapter box, and is easily extracted by other people and carried off.

2. The access device is embedded within the multimedia device.

3. Because of shortcoming 1, maintenance or exchange is inconvenient.

4. Because of restrictions imposed by the design of the multimedia device itself, thus, the prior art prevents separately extending the transmission interfaces.

5. Troublesome to the user and manufacturing cost is high; moreover, compatibility of the multimedia device is low.

### ADVANTAGES OF THE PRESENT INVENTION

1. The entire connector module D is inserted into the housing C and assumes an integral form therewith.

2. Because of advantage 1, thus, use of the key G enables the connector module to be directly pulled out.

3. Because of advantage 1, thus, a user is able to conveniently exchange the connector module D.

4. Configured with the memory card slots F3 having diverse specifications.

5. Because of advantage 2, thus, inserting of the readable devices H having diverse specifications is facilitated.

6. The expansion devices F2 of the connector module D enable achieving the objective of providing extensible transmission interfaces.

7. Because of advantage 2, thus, compatibility of the access device B is increased.

8. Convenient for the user to operate, and achieves the objective of saving on cost and man-hours.

9. Provided with advancement and practicability.

10. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A multimedia multifunctional photo kiosk combination device, wherein a multimedia device enables access to a media card through photo kiosk machines to develop photographs and provide multimedia services, and enables receiving multimedia data using diverse access interface, the multimedia device comprises a display interface and an access device;
the access device comprises a housing and a connector module, and the housing is configured with a first connector and an embedding slot, the embedding slot enables the connector module to be disposed and clamped therein, wherein an insertion hole is defined in the connector module, and the insertion hole enables a key to be inserted therein to enable the connector module to be pulled out, accordingly, the key need only be inserted into the insertion hole of the connector module to enable the connector module to be pulled out and separated from the housing, and thereby achieve the objectives of convenient exchange and reduction in time cost.

2. The multimedia multifunctional photo kiosk combination device according to claim 1, wherein the connector module comprises a circuit board and a faceplate; the circuit board is configured with a second connector, a plurality of memory card slots and expansion devices.

3. The multimedia multifunctional photo kiosk combination device according to claim 1, wherein the connector module is connected to the housing the first connector of the housing to connect to the second connector of the connector module, thereby achieving the objectives of electrical conductance and enabling transmission of data.

4. The multimedia multifunctional photo kiosk combination device according to claim 2, wherein the expansion devices are separately installed with expansion members, the expansion members are configured as wireless devices, printer ports, blue-tooth, flash drives, credit card card readers and related expansion members able to transmit data through either housing or connector module.

5. The multimedia multifunctional photo kiosk combination device according to claim 2, wherein the connector module is configured with the plurality of memory card slots, and the memory card slots are configured to enable readable devices to be inserted therein, including CF cards (Compact Flash Memory Card), MS cards (Memory Stick Memory Card), SD cards (Secure Digital Memory Card), Mini SD cards (Mini Secure Digital Memory Card), Micro SD cards (Micro Secure Digital Memory Card), MMC cards (Multi Media Memory Card), RSMMC cards (Reduced Size Multi Media Memory Card), SM cards (Smart Media Memory Card), xD cards (xD-Picture Card), M2 cards (MS Micro Card), MMC Micro cards (Multi Media Memory Card Micro) and related readable cards able to be inserted into the memory card slots.

6. The multimedia multifunctional photo combination device according to claim 2, wherein a plurality of insertion slots are defined in the faceplate corresponding to the memory card slots and a plurality of indicator lights corresponding to the memory card slots.

7. The multimedia multifunctional photo kiosk combination device according to claim 1, wherein the access device is further configured with 3.5 inch, 5.25 inch and a plurality of specifications, and is applicable for use in a desktop computer, a notebook computer and related devices.
